(19) United States
(12) Patent Application Publication
(10) Pub. No.: US 2013/0050710 A1
(43) Pub. Date: Feb. 28, 2013

(54) OBJECT DETECTING DEVICE AND INFORMATION ACQUIRING DEVICE

(71) Applicant: SANYO Electric Co., Ltd., Muriguchi-shi (JP)

(72) Inventors: Atsushi YAMAGUCHI, Ibi-gun (JP); Hiroyuki MUTO, Nagoya-shi (JP)

(73) Assignee: SANYO ELECTRIC CO., LTD., Moriguchi-shi (JP)

(21) Appl. No.: 13/663,439

(22) Filed: Oct. 29, 2012

Related U.S. Application Data
(63) Continuation of application No. PCT/JP2012/059450, filed on Apr. 6, 2012.

(30) Foreign Application Priority Data
Apr. 25, 2011 (JP) 2011-97595

(51) Int. Cl. G01B 11/25

(52) U.S. Cl. 356/610

(57) ABSTRACT

The information acquiring device includes a projection optical system which projects laser light onto a target area with a predetermined dot pattern; a light receiving optical system which is aligned with the projection optical system away therefrom by a predetermined distance, and has an image pickup element for capturing an image of the target area; a correcting section which divides a captured image obtained by capturing the image of the target area by the image pickup element at a time of actual measurement into a plurality of correction areas, and correcting a pixel value of a pixel in the correction area with use of a minimum pixel value among all pixel values of pixels in the correction area for generating a corrected image; and an information acquiring section which acquires three-dimensional information of an object in the target area, based on the corrected image generated by the correcting section.

This application claims priority under 35 U.S.C. Section 119 of Japanese Patent Application No. 2011-97595 filed on Apr. 25, 2011, entitled “OBJECT DETECTING DEVICE AND INFORMATION ACQUIRING DEVICE”. The disclosure of the above application is incorporated herein by reference.

### BACKGROUND OF THE INVENTION

1. Field of the Invention

The present invention relates to an object detecting device for detecting an object in a target area, based on a state of reflected light when light is projected onto the target area, and an information acquiring device incorporated with the object detecting device.

2. Disclosure of Related Art

Conventionally, there has been developed an object detecting device using light in various fields. An object detecting device incorporated with a so-called distance image sensor is operable to detect not only a two-dimensional image on a two-dimensional plane but also a depthwise shape or a movement of an object to be detected. In such an object detecting device, light in a predetermined wavelength band is projected from a laser light source or an LED (Light Emitting Diode) onto a target area, and light reflected on the target area is received by a light receiving element such as a CMOS image sensor. Various types of sensors are known as the distance image sensor.

A distance image sensor configured to irradiate a target area with laser light having a predetermined dot pattern is operable to receive a dot pattern reflected on the target area by an image sensor, and to detect a distance to each portion of an object to be detected, based on a light receiving position of the dot pattern on the image sensor, using a triangulation method (see e.g. pp. 1279-1280, the 19th Annual Conference Proceedings (Sep. 18-20, 2001) by the Robotics Society of Japan).

According to the above method, for instance, laser light having a dot pattern is emitted in a state that a reflection plane is disposed at a position away from an irradiation portion of laser light by a predetermined distance at the time of the laser light emission, and a dot pattern of laser light irradiated onto the image sensor is held as a template. Then, a matching operation is performed between a dot pattern of laser light irradiated onto the image sensor at the time of actual measurement, and the dot pattern held in the template for detecting a shift position of a segment area of the dot pattern on the template, on the dot pattern at the time of actual measurement. A distance to each portion of the target area corresponding to each segment area is calculated based on the shift amount.

In the object detecting device thus constructed, at the time of actual measurement, light (e.g. interior illumination or sunlight) other than a dot pattern may be entered to the image sensor. In such a case, light other than the dot pattern may be superimposed as background light in outputting from the image sensor, which may make it difficult or impossible to properly perform a matching operation with respect to the dot pattern held in the template. As a result, detection precision on a distance to each portion of an object to be detected may be degraded.

### SUMMARY OF THE INVENTION

A first aspect of the invention is directed to an information acquiring device for acquiring information on a target area using light. The information acquiring device according to the first aspect includes a projection optical system which projects laser light onto the target area with a predetermined dot pattern; a light receiving optical system which is aligned with the projection optical system away from the projection optical system by a predetermined distance, and has an image pickup element for capturing an image of the target area; a correcting section which divides a captured image obtained by capturing the image of the target area by the image pickup element at a time of actual measurement into a plurality of correction areas, and correcting a pixel value of a pixel in the correction area with use of a minimum pixel value among all pixel values of pixels in the correction area for generating a corrected image; and an information acquiring section which acquires three-dimensional information of an object in the target area, based on the corrected image generated by the correcting section.

A second aspect of the invention is directed to an object detecting device. The object detecting device according to the second aspect has the information acquiring device according to the first aspect.

### BRIEF DESCRIPTION OF THE DRAWINGS

These and other objects, and novel features of the present invention will become more apparent upon reading the following detailed description of the embodiment along with the accompanying drawings.

FIG. 1 is a diagram showing an arrangement of an object detecting device embodying the invention.

FIG. 2 is a diagram showing an arrangement of an information acquiring device and an information processing device in the embodiment.

FIG. 3A is a diagram showing an irradiation state of laser light with respect to a target area in the embodiment, and FIG. 3B is a diagram showing a light receiving state of laser light on an image sensor.

FIGS. 4A and 4B are diagrams for describing a reference template setting method in the embodiment.

FIGS. 5A through 5C are diagrams for describing a distance detecting method in the embodiment.

FIGS. 6A and 6C are diagrams showing captured images in the case where background light is entered, and FIG. 6B is a diagram showing matching results in the embodiment.

FIG. 7A is a flowchart showing a series of processings from an image pickup processing to a distance calculation processing, and FIG. 7B is a flowchart showing a captured image correction processing in the embodiment.

FIGS. 8A through 8E are diagrams showing the captured image correction processing in the embodiment.

FIGS. 9A through 9C are diagrams showing correction area dividing examples as modifications of the embodiment.

FIGS. 10A and 10C are diagrams showing corrected images of captured images, and FIG. 10B is a diagram showing matching results in the embodiment.

The drawings are provided mainly for describing the present invention, and do not limit the scope of the present invention.

### DESCRIPTION OF PREFERRED EMBODIMENTS

In the following, an embodiment of the invention is described referring to the drawings. In the embodiment, there is exemplified an information acquiring device for irradiating a target area with laser light having a predetermined dot pattern.

In the embodiment, a DOE 114 corresponds to a “diffractive optical element” in the claims. A CMOS image sensor 124 corresponds to an “image pick-up element” in the claims. A captured image corrector 21b corresponds to a “correcting section” in the claims. A distance calculator 21c corresponds to an “information acquiring section” in the claims. The description regarding the correspondence between the claims and the embodiment is merely an example, and the claims are not limited by the description of the embodiment.

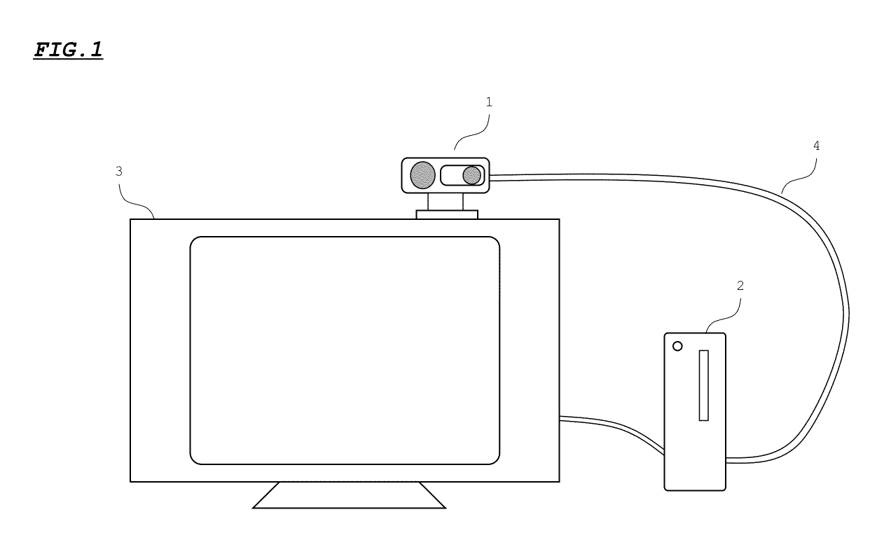

FIG. 1 describes a schematic arrangement of an object detecting device according to the first embodiment. As shown in FIG. 1, the object detecting device is provided with an information acquiring device 1, and an information processing device 2. A TV 3 is controlled by a signal from the information processing device 2. A device constituted of the information acquiring device 1 and the information processing device 2 corresponds to an object detecting device of the invention.

The information acquiring device 1 projects infrared light to the entirety of a target area, and receives reflected light from the target area by a CMOS image sensor to thereby acquire a distance (hereinafter, called as “three-dimensional distance information”) to each part of an object in the target area. The acquired three-dimensional distance information is transmitted to the information processing device 2 through a cable 4.

The information processing device 2 is e.g. a controller for controlling a TV or a game machine, or a personal computer. The information processing device 2 detects an object in a target area based on three-dimensional distance information received from the information acquiring device 1, and controls the TV 3 based on a detection result.

For instance, the information processing device 2 detects a person based on received three-dimensional distance information, and detects a motion of the person based on a change in the three-dimensional distance information. For instance, in the case where the information processing device 2 is a controller for controlling a TV, the information processing device 2 is installed with an application program operable to detect a gesture of a user based on received three-dimensional distance information, and output a control signal to the TV 3 in accordance with the detected gesture. In this case, the user is allowed to control the TV 3 to execute a predetermined function such as switching the channel or turning up/down the volume by performing a certain gesture while watching the TV 3.

Further, for instance, in the case where the information processing device 2 is a game machine, the information processing device 2 is installed with an application program operable to detect a motion of a user based on received three-dimensional distance information, and operate a character on a TV screen in accordance with the detected motion to change the match status of a game. In this case, the user is allowed to play the game as if the user himself or herself is the character on the TV screen by performing a certain action while watching the TV 3.

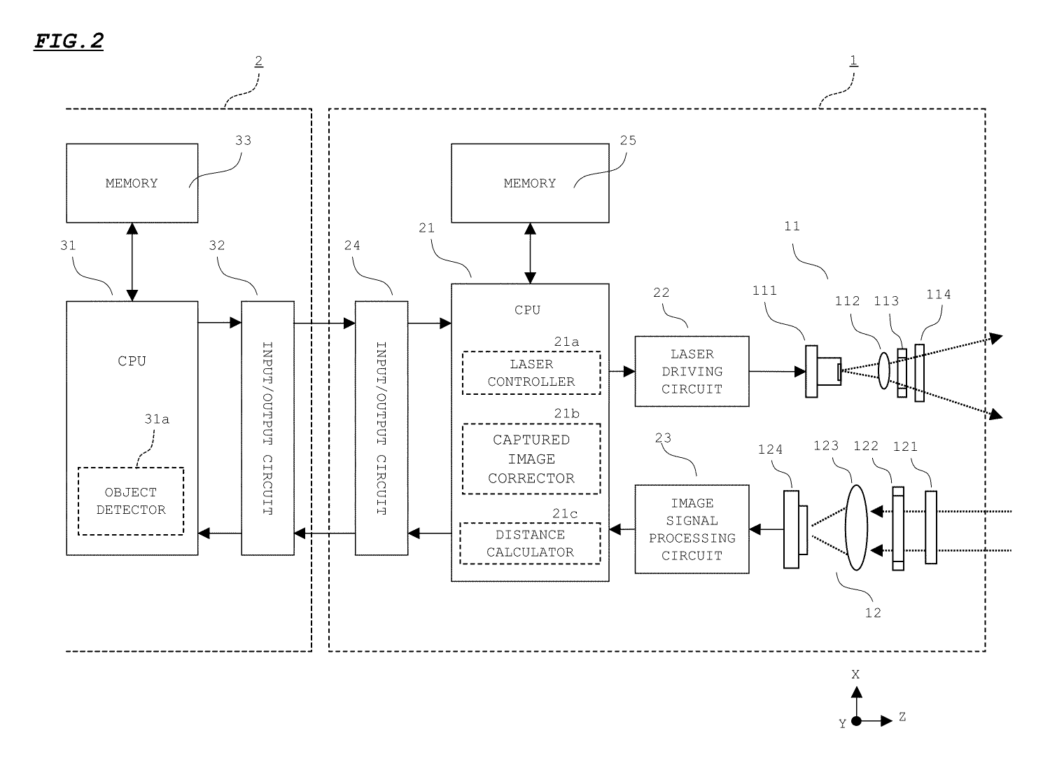

FIG. 2 is a diagram showing an arrangement of the information acquiring device 1 and the information processing device 2.

The information acquiring device 1 is provided with a projection optical system 11 and a light receiving optical system 12, as optical systems. The projection optical system 11 and the light receiving optical system 12 are disposed to be aligned in X-axis direction in the information acquiring device 1.

The projection optical system 11 is provided with a laser light source 111, a collimator lens 112, an aperture 113, and a DOE (Diffractive Optical Element) 114. Further, the light receiving optical system 12 is provided with a filter 121, an aperture 122, an imaging lens 123, and a CMOS image sensor 124. In addition to the above, the information acquiring device 1 is provided with a CPU (Central Processing Unit) 21, a laser driving circuit 22, an image signal processing circuit 23, an input/output circuit 24, and a memory 25, which constitute a circuit section.

The laser light source 111 outputs laser light of a narrow wavelength band of or about 830 nm. The collimator lens 112 converts the laser light emitted from the laser light source 111 into light (hereinafter, simply called as “parallel light”) which is slightly spread with respect to parallel light. The aperture 113 adjusts the light flux section of laser light into a predetermined shape.

The DOE 114 has a diffraction pattern on a light incident surface thereof. Laser light entered to the DOE 114 is converted into laser light having a dot pattern by diffractive action of the diffractive pattern, and is irradiated onto a target area. The diffraction pattern has such a structure that a step-type diffraction hologram is formed by a predetermined pattern. The pattern and the pitch of the diffraction hologram are adjusted in such a manner that laser light which is collimated into parallel light by the collimator lens 112 is converted into laser light having a dot pattern.

The DOE 114 irradiates the target area with laser light entered from the collimator lens 112, as laser light having such a dot pattern that about thirty thousand dots radially extend. The size of each dot of the dot pattern is set depending on the beam size of laser light to be entered to the DOE 114. Laser light (zero-th order diffraction light) which is not diffracted by the DOE 114 is transmitted through the DOE 114 and travels in forward direction.

Laser light reflected on the target area is entered to the imaging lens 123 through the filter 121 and the aperture 122.

The filter 121 is a band-pass filter which transmits light of a wavelength band including the emission wavelength (of or about 830 nm) of the laser light source 111, and blocks light of the wavelength band of visible light. The filter 121 is not a narrow wavelength band filter which transmits only light of a wavelength band of or about 830 nm, but is constituted of an inexpensive filter which transmits light of a relatively wide wavelength band including 830 nm.

The aperture 122 converges external light to be in conformity with the F-number of the imaging lens 123. The imaging lens 123 condenses the light entered through the aperture 122 on the CMOS image sensor 124.

The CMOS image sensor 124 receives light condensed on the imaging lens 123, and outputs a signal (electric charge) corresponding to a received light amount to the image signal processing circuit 23 pixel by pixel. In this example, the CMOS image sensor 124 is configured to perform high-speed signal output so that a signal (electric charge) of each pixel can be outputted to the image signal processing circuit 23 with a high response from a light receiving timing at each of the pixels. The resolution of the CMOS image sensor 124 corresponds to the resolution of VGA (Video Graphics Array), and the number of effective pixels of the CMOS image sensor 124 is set to 640 pixels by 480 pixels.

The CPU 21 controls each parts in accordance with a control program stored in the memory 25. The control program causes the CPU 21 to function as a laser controller 21a for controlling the laser light source 111, a captured image corrector 21b for removing background light from a captured image obtained by the image signal processing circuit 23, and a distance calculator 21c for generating three-dimensional distance information.

The laser driving circuit 22 drives the laser light source 111 in accordance with a control signal from the CPU 21. The image signal processing circuit 23 controls the CMOS image sensor 124 to sequentially read a signal (electric charge) of each pixel generated in the CMOS image sensor 124 line by line. Then, the image signal processing circuit 23 sequentially outputs the read signals to the CPU 21. The CPU 21 generates a corrected image in which background light is removed, based on a signal (image signal) to be supplied from the image signal processing circuit 23, by a processing to be performed by the captured image corrector 21b. Thereafter, the CPU 21 calculates a distance from the information acquiring device 1 to each portion of an object to be detected by a processing to be performed by the distance calculator 21c. The input/output circuit 24 controls data communication with the information processing device 2.

The information processing device 2 is provided with a CPU 31, an input/output circuit 32, and a memory 33. The information processing device 2 is provided with e.g. an arrangement for communicating with the TV 3, or a drive device for reading information stored in an external memory such as a CD-ROM and installing the information in the memory 33, in addition to the arrangement shown in FIG. 2. The arrangements of the peripheral circuits are not shown in FIG. 2 to simplify the description.

The CPU 31 controls each of the parts of the information processing device 2 in accordance with a control program (application program) stored in the memory 33. By the control program, the CPU 31 has a function of an object detector 31a for detecting an object in an image. The control program is e.g. read from a CD-ROM by an unillustrated drive device, and is installed in the memory 33.

For instance, in the case where the control program is a game program, the object detector 31a detects a person and a motion thereof in an image based on three-dimensional distance information supplied from the information acquiring device 1. Then, the information processing device 2 causes the control program to execute a processing for operating a character on a TV screen in accordance with the detected motion.

Further, in the case where the control program is a program for controlling a function of the TV 3, the object detector 31a detects a person and a motion (gesture) thereof in the image based on three-dimensional distance information supplied from the information acquiring device 1. Then, the information processing device 2 causes the control program to execute a processing for controlling a predetermined function (such as switching the channel or adjusting the volume) of the TV 3 in accordance with the detected motion (gesture).

The input/output circuit 32 controls data communication with the information acquiring device 1.

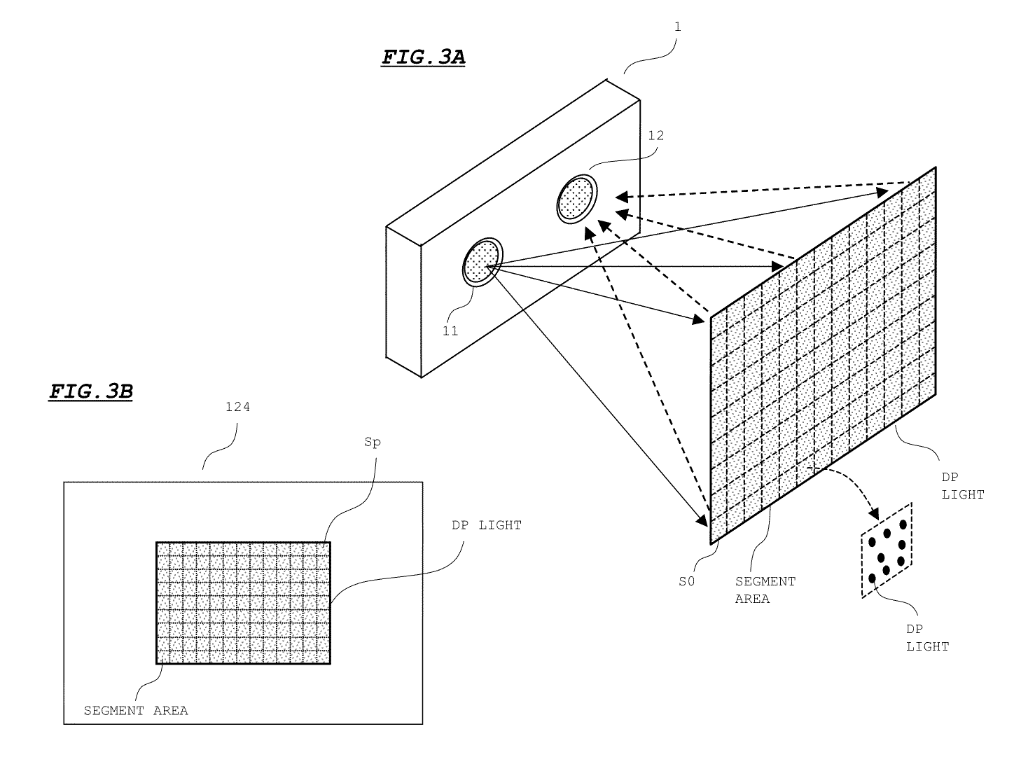

FIG. 3A is a diagram schematically showing an irradiation state of laser light onto a target area. FIG. 3B is a diagram schematically showing a light receiving state of laser light on the CMOS image sensor 124. To simplify the description, FIG. 3B shows a light receiving state in the case where a flat plane (screen) is disposed on a target area.

As shown in FIG. 3A, the projection optical system 11 irradiates laser light having a dot pattern (hereinafter, the entirety of the laser light having the dot pattern is called as “DP light”) on a target area. FIG. 3A shows a light flux area of DP light by a solid-line frame. In the light flux of DP light, dot areas (hereinafter, simply called as “dots”) in which the intensity of laser light is increased by a diffractive action of the DOE 114 locally appear in accordance with the dot pattern by the diffractive action of the DOE 114.

To simplify the description, in FIG. 3A, a light flux of DP light is divided into segment areas arranged in the form of a matrix. Dots locally appear with a unique pattern in each segment area. The dot appearance pattern in a certain segment area differs from the dot appearance patterns in all the other segment areas. With this configuration, each segment area is identifiable from all the other segment areas by a unique dot appearance pattern of the segment area.

When a flat plane (screen) exists in a target area, the segment areas of DP light reflected on the flat plane are distributed in the form of a matrix on the CMOS image sensor 124, as shown in FIG. 3B. For instance, light of a segment area S0 in the target area shown in FIG. 3A is entered to a segment area Sp shown in FIG. 3B, on the CMOS image sensor 124. In FIG. 3B, a light flux area of DP light is also indicated by a solid-line frame, and to simplify the description, a light flux of DP light is divided into segment areas arranged in the form of a matrix in the same manner as shown in FIG. 3A.

The distance calculator 21c detects a position of each segment area on the CMOS image sensor 124, and detects a distance to a position corresponding to each segment area of an object to be detected, based on the detected position of each segment area, using the triangulation method. The details of the above detection method is disclosed in e.g. pp. 1279-1280, the 19th Annual Conference Proceedings (Sep. 18-20, 2001) by the Robotics Society of Japan.

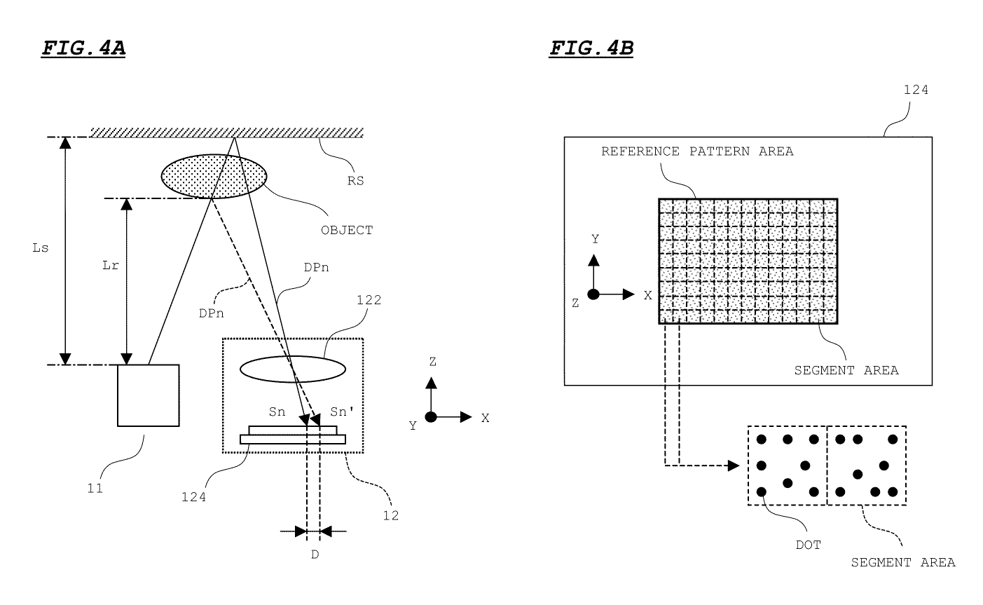

FIGS. 4A, 4B are diagrams schematically showing a reference template generation method for use in the aforementioned distance detection.

As shown in FIG. 4A, at the time of generating a reference template, a reflection plane RS perpendicular to Z-axis direction is disposed at a position away from the projection optical system 11 by a predetermined distance Ls. Then, DP light is emitted from the projection optical system 11 for a predetermined time Te in the above state. The emitted DP light is reflected on the reflection plane RS, and is entered to the CMOS image sensor 124 in the light receiving optical system 12. By performing the above operation, an electrical signal at each pixel is outputted from the CMOS image sensor 124. The value (pixel value) of the electrical signal at each outputted pixel is expanded in the memory 25 shown in FIG. 2. To simplify the description, the description is made based on an irradiation state of DP light which is irradiated onto the CMOS image sensor 124, in place of using a pixel value developed in the memory 25.

As shown in FIG. 4B, a reference pattern area for defining an irradiation area of DP light on the CMOS image sensor 124 is set, based on the pixel values expanded in the memory 25. Further, the reference pattern area is divided into segment areas in the form of a matrix. As described above, dots locally appear with a unique pattern in each segment area. Accordingly, in the example shown in FIG. 4B, each segment area has a different pattern of pixel values. Each one of the segment areas has the same size as all the other segment areas.

The reference template is configured in such a manner that pixel values of the pixels included in each segment area set on the CMOS image sensor 124 are correlated to the segment area.

Specifically, the reference template includes information relating to the position of a reference pattern area on the CMOS image sensor 124, pixel values of all the pixels included in the reference pattern area, and information for use in dividing the reference pattern area into segment areas. The pixel values of all the pixels included in the reference pattern area correspond to a dot pattern of DP light included in the reference pattern area. Further, pixel values of pixels included in each segment area are acquired by dividing a mapping area on pixel values of all the pixels included in the reference pattern area into segment areas. The reference template may retain pixel values of pixels included in each segment area, for each segment area.

The reference template thus configured is stored in the memory 25 shown in FIG. 2 in a non-erasable manner. The reference template stored in the memory 25 is referred to in calculating a distance from the projection optical system 11 to each portion of an object to be detected.

For instance, in the case where an object is located at a position nearer to the distance Ls shown in FIG. 4A, DP light (DPn) corresponding to a segment area Sn on the reference pattern is reflected on the object, and is entered to an area Sn′ different from the segment area Sn. Since the projection optical system 11 and the light receiving optical system 12 are adjacent to each other in X-axis direction, the displacement direction of the area Sn′ relative to the segment area Sn is aligned in parallel to X-axis. In the case shown in FIG. 4A, since the object is located at a position nearer to the distance Ls, the area Sn′ is displaced relative to the segment area Sn in plus X-axis direction. If the object is located at a position farther from the distance Ls, the area Sn′ is displaced relative to the segment area Sn in minus X-axis direction.

A distance Lr from the projection optical system 11 to a portion of the object irradiated with DP light (DPn) is calculated, using the distance Ls, and based on a displacement direction and a displacement amount of the area Sn′ relative to the segment area Sn, by a triangulation method. A distance from the projection optical system 11 to a portion of the object corresponding to the other segment area is calculated in the same manner as described above.

In performing the distance calculation, it is necessary to detect to which position, a segment area Sn of the reference template has displaced at the time of actual measurement. The detection is performed by performing a matching operation between a dot pattern of DP light irradiated onto the CMOS image sensor 124 at the time of actual measurement, and a dot pattern included in the segment area Sn.

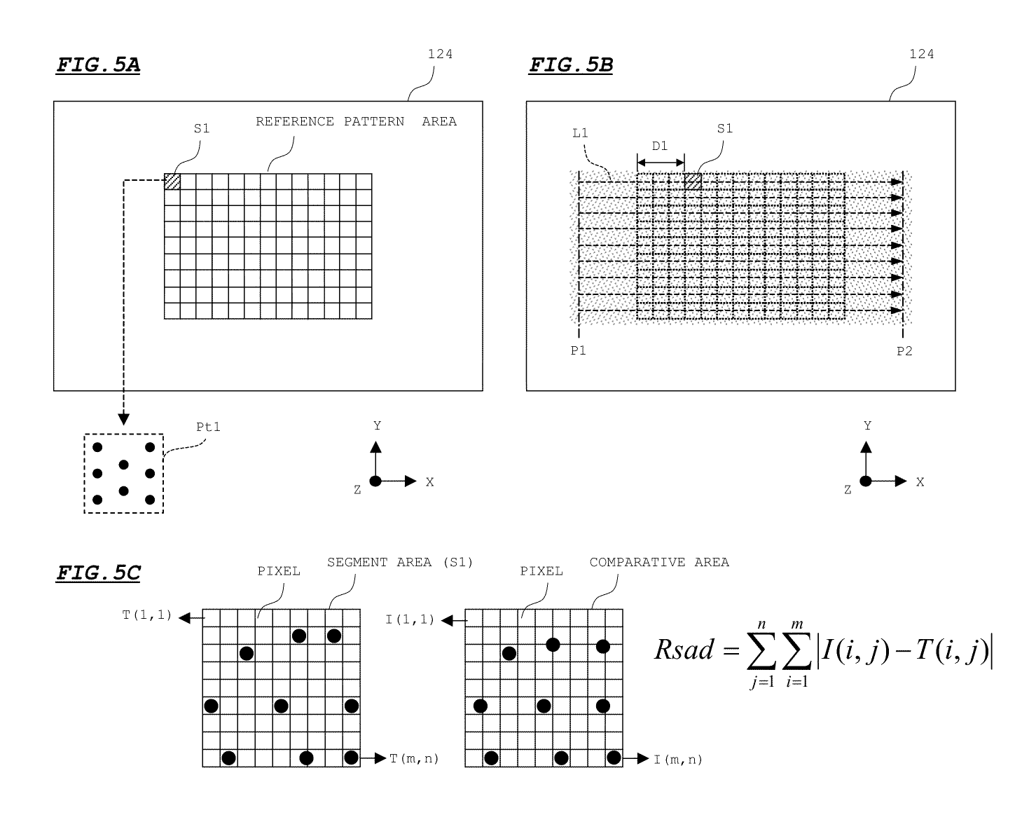

FIGS. 5A through 5C are diagrams for describing the aforementioned detection method. FIG. 5A is a diagram showing a state as to how a reference pattern area is set on the CMOS image sensor 124, FIG. 5B is a diagram showing a segment area searching method to be performed at the time of actual measurement, and FIG. 5C is a diagram showing a matching method between an actually measured dot pattern of DP light, and a dot pattern included in a segment area of a reference template. In this example, a segment area is constituted of 9 pixels in vertical direction and 9 pixels in horizontal direction.

For instance, in the case where a displacement position of a segment area 51 at the time of actual measurement shown in FIG. 5A is searched, as shown in FIG. 5B, the segment area S1 is fed pixel by pixel in X-axis direction in a range from P1 to P2 for obtaining a matching degree between the dot pattern of the segment area S1, and the actually measured dot pattern of DP light, at each feeding position. In this case, the segment area S1 is fed in X-axis direction only on a line L1 passing an uppermost segment area group in the reference pattern area. This is because, as described above, each segment area is normally displaced only in X-axis direction from a position of the reference pattern area at the time of actual measurement. In other words, the segment area S1 is conceived to be on the uppermost line L1. By performing a searching operation only in X-axis direction as described above, the processing load for searching is reduced.

At the time of actual measurement, a segment area may be deviated in X-axis direction from the range of the reference pattern area, depending on the position of an object to be detected. In view of the above, the range from P1 to P2 is set wider than the X-axis directional width of the reference pattern area.

At the time of detecting the matching degree, an area (comparative area) of the same size as the segment area S1 is set on the line L1, and a degree of similarity between the comparative area and the segment area S1 is obtained. Specifically, there is obtained a difference between the pixel value of each pixel in the segment area S1, and the pixel value of a pixel, in the comparative area, corresponding to the pixel in the segment area S1. Then, a value Rsad which is obtained by summing up the difference with respect to all the pixels in the comparative area is acquired as a value representing the degree of similarity.

For instance, as shown in FIG. 5C, in the case where pixels of m columns by n rows are included in one segment area, there is obtained a difference between a pixel value T (i, j) of a pixel at i-th column, j-th row in the segment area, and a pixel value I (i, j) of a pixel at i-th column, j-th row in the comparative area. Then, a difference is obtained with respect to all the pixels in the segment area, and the value Rsad is obtained by summing up the differences. In other words, the value Rsad is calculated by the following formula.

$$Rsad = {\sum }_{j = 1}^{n} {\sum }_{i = 1}^{m} \vert I ( i , j ) - T ( i , j ) \vert$$

As the value Rsad is smaller, the degree of similarity between the segment area and the comparative area is high.

At the time of a searching operation, the comparative area is sequentially set in a state that the comparative area is displaced pixel by pixel on the line L1. Then, the value Rsad is obtained for all the comparative areas on the line L1. A value Rsad smaller than a threshold value is extracted from among the obtained values Rsad. In the case where there is no value Rsad smaller than the threshold value, it is determined that the searching operation of the segment area S1 has failed. In this case, a comparative area having a smallest value among the extracted values Rsad is determined to be the area to which the segment area S1 has moved. The segment areas other than the segment area S1 on the line L1 are searched in the same manner as described above. Likewise, segment areas on the other lines are searched in the same manner as described above by setting a comparative area on the other line.

In the case where the displacement position of each segment area is searched from the dot pattern of DP light acquired at the time of actual measurement in the aforementioned manner, as described above, the distance to a portion of the object to be detected corresponding to each segment area is obtained based on the displacement positions, using a triangulation method.

In performing the distance detection operation, it is necessary to accurately detect a distribution state of DP light (light at each dot position) on the CMOS image sensor 124. However, at the time of actual measurement, light other than DP light, for instance, interior illumination or sunlight may be entered to the CMOS image sensor 124. In such a case, light other than a dot pattern may be superimposed on an image captured by the CMOS image sensor 124, as background light. As a result, it may be difficult to accurately detect a distribution state of DP light.

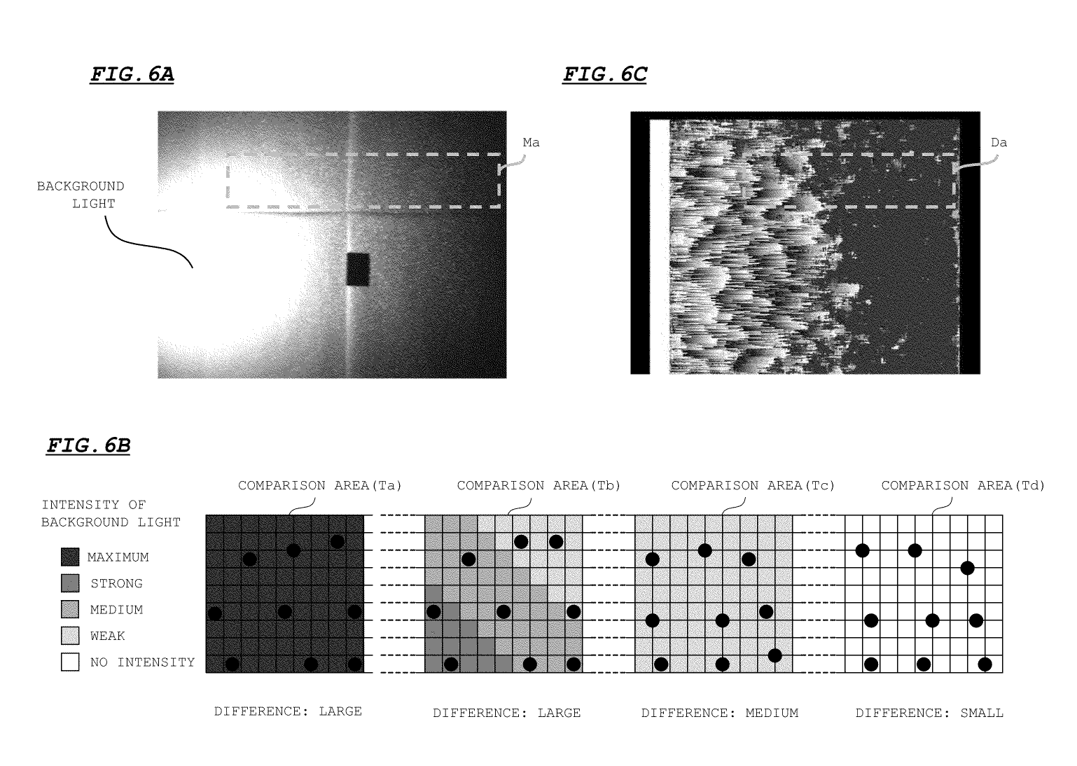

FIGS. 6A through 6C are diagrams showing an example of distance measurement, in the case where background light is entered to the CMOS image sensor 124.

FIG. 6A is a diagram showing a captured image, in which light other than a dot pattern is entered as background light. Referring to FIG. 6A, a portion whose color is closer to white has a higher luminance (pixel value), and a portion whose color is closer to black has a lower luminance. A black object at a middle of the captured image is an image of a black test paper strip. There exists no object other than the black test paper strip in the target area. A flat screen is disposed at a position behind the black test paper strip by a predetermined distance.

Referring to FIG. 6A, about thirty thousand dots are indicated by tiny white dots in a region including a region which is unrecognizable due to incidence of background light. Very bright background light is entered to a left-side middle portion in the image shown in FIG. 6A, and the left-side middle portion appears as a white portion substantially in the form of a circle. The left-side middle portion is a region where the CMOS image sensor 124 is saturated (in other words, the luminance of a pixel is maximum), and the tiny white dots are difficult or impossible to be recognized. Further, the captured image shown in FIG. 6A is such that as the region is away from the center of entered background light, the intensity of background light decreases, and the color gradually turns black.

FIG. 6B is a diagram schematically showing examples of comparison areas in the region Ma enclosed by the white dash line in the captured image shown in FIG. 6A. Referring to FIG. 6B, one square corresponds to one pixel in the captured image, and a black circle indicates a dot of DP light. As the color density of the square increases, the intensity of background light increases. It should be noted that only a dot pattern is captured in advance in a state that the background light shown in FIG. 6A does not exist, for a segment area of a reference template, in which a matching operation is performed with respect to each of the comparison areas.

Referring to FIG. 6B, the comparison area Ta indicates a part of the region Ma shown in FIG. 6A, where left-end background light is entered with a strong intensity.

Regarding the comparison area Ta, background light of a strong intensity is entered, and the luminance values of all the pixels including pixel positions where dots are entered are high. Accordingly, in the comparison area Ta, the sum Rsad of pixel value differences with respect to a segment area of the reference template is very large, and accurate matching determination cannot be expected.

The comparison area Tb indicates a part of the region Ma shown in FIG. 6A, where background light is gradually weakened.

The comparison area Tb includes a region where the intensity of background light is strong, and a region where the intensity of background light is weak. In this example, the luminances of pixels are high in the region where the intensity of background light is strong, and the luminances of pixels are low in the region where the intensity of background light is weak. In this example, in the comparison area Tb, the sum Rsad of pixel value differences with respect to a segment area of the reference template is also very large, and accurate matching determination cannot be expected.

The comparison area Tc indicates a part of the region Ma shown in FIG. 6A, where background light of a weak intensity is uniformly entered.

Regarding the comparison area Tc, since background light of a weak intensity is uniformly entered, the luminances of all the pixels are slightly increased. In the example of the comparison area Tc, although the pixel value difference per pixel with respect to a segment area of the reference template is small, the sum. Rsad of pixel value differences with respect to all the pixels in the segment area is large to some extent. Accordingly, in this example, it is also difficult to perform accurate matching determination.

The comparison area Td indicates a right-end part of the region Ma shown in FIG. 6A, which is not influenced by background light.

Since the comparison area Td is free from an influence of background light, the sum Rsad of pixel value differences between the comparison area Td and a segment area of the reference template is small, and accordingly, accurate matching determination may be performed.

FIG. 6C is a diagram showing a measurement result, in the case where a distance measurement operation is performed after a matching operation is performed with respect to the captured image shown in FIG. 6A, with use of the detection method (see FIGS. 5A through 5C). In the measurement, even in the case where the sum Rsad of pixel value differences exceeds a threshold value in all the comparison areas, and accordingly the matching operation has failed, distances are obtained assuming that a comparison area where the value Rsad is smallest is a shift position of the segment area. Referring to FIG. 6C, a position corresponding to a segment area where the measured distance is farther is indicated by a color closer to black, and a position corresponding to a segment area where the measured distance is nearer is indicated by a color closer to white.

As described above, in the present measurement, a flat screen is disposed in a target area including a black test paper strip. Accordingly, in the case where a matching operation is properly performed, a uniform color close to black is shown as a measurement result, because the entirety of the screen is determined to be equally distanced. On the other hand, in the measurement result shown in FIG. 6C, a region where background light of a strong intensity is entered, and regions in the vicinity of the above region are indicated with a color closer to white. This shows that an erroneous matching operation is performed, and the distance is erroneously measured.

Referring to FIG. 6C, the region Da enclosed by the white dash line shows a matching result in the region Ma shown in FIG. 6A. FIG. 6C clearly shows that a matching operation has failed, as the region comes closer to the left side; and a matching operation is successful, as the region comes closer to the right side. In particular, it is clear that a matching operation has failed in a wide region including a left-end part (comparison area Ta) where background light of a strong intensity is entered, and regions (comparison areas Tb and Tc) in the vicinity of the region where background light of a strong intensity is entered.

As described above, if background light of a strong intensity is entered, the matching rate remarkably decreases not only in a region where the CMOS image sensor 124 is saturated, but also in regions in the vicinity of the above region.

Accordingly, in this embodiment, the captured image corrector 21b performs a captured image correction processing for raising the matching rate, while suppressing an influence of background light.

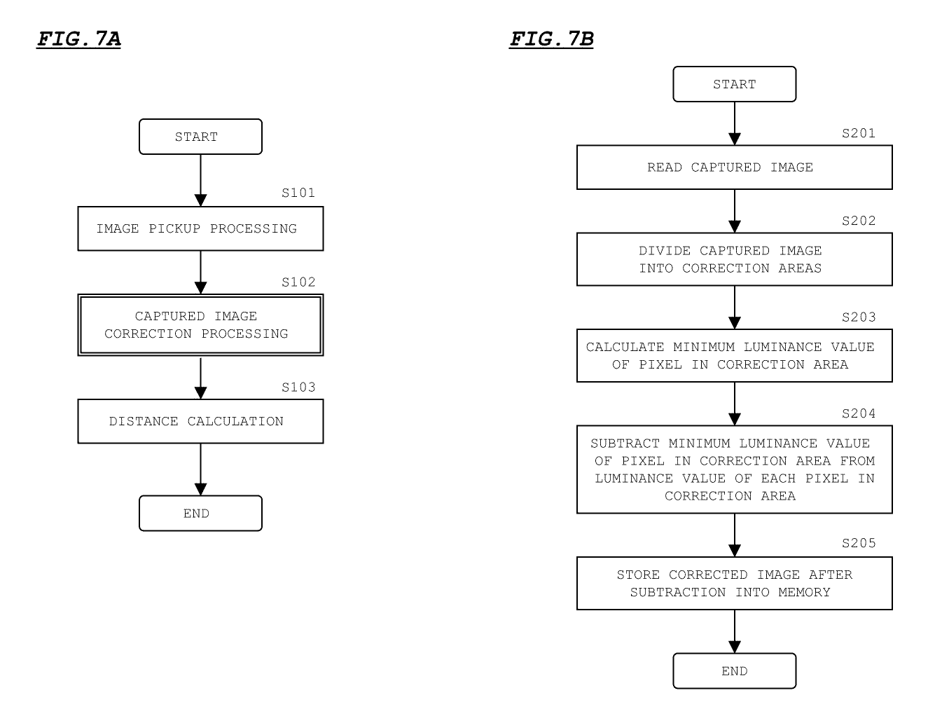

FIGS. 7A through 9C are diagrams for describing the captured image correction processing.

FIG. 7A is a flowchart of a series of processings from an image pickup processing to a distance calculation processing to be performed by the CPU 21. The CPU 21 emits laser light by the laser driving circuit 22 shown in FIG. 2, and the image signal processing circuit 23 generates a captured image, based on a signal of each pixel outputted from the CMOS image sensor 124 (S101). Thereafter, the captured image corrector 21b performs a correction processing for removing background light from the captured image (S102).

Thereafter, the distance calculator 21c calculates a distance from the information acquiring device 1 to each portion of an object to be detected, with use of the corrected captured image (S103).

FIG. 7B is a flowchart showing the captured image correction processing of S102 shown in FIG. 7A.

The captured image corrector 21b reads the captured image generated by the image signal processing circuit 23 (S201), and divides the captured image into correction areas each having a predetermined pixel number in horizontal direction and a predetermined pixel number in vertical direction (S202).

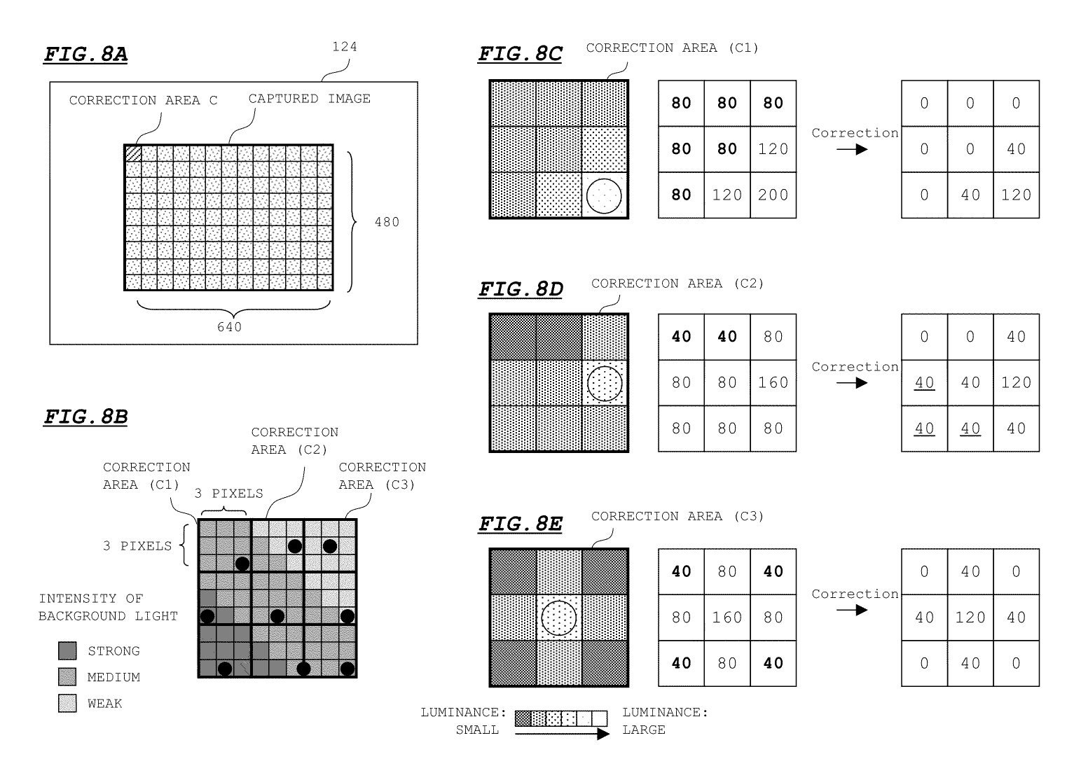

FIGS. 8A and 8B are diagrams showing a captured image actually obtained by the CMOS image sensor 124, and a correction area setting state. FIG. 8B is a diagram showing a correction area dividing example at a position of the comparison area Tb shown in FIG. 6B.

As shown in FIG. 8A, a captured image having a dot pattern is constituted of 640 pixels by 480 pixels, and is divided into correction areas C each having a predetermined pixel number in horizontal direction and a predetermined pixel number in vertical direction by the captured image corrector 21b. In this example, the number of dots created by the DOE 114 is about thirty thousands, and the total pixel number of the captured image is about three hundred thousands. In other words, substantially one dot is included in each ten pixels of the captured image. Accordingly, assuming that the size of the correction area C is 3 pixels by 3 pixels (total pixel number is 9), it is highly likely that at least one or more pixels free of an influence of a dot is included in the correction area C. In view of the above, in this embodiment, as shown in FIG. 8B, a captured image is divided into correction areas C each having the size of 3 pixels by 3 pixels (total pixel number is 9).

Referring back to FIG. 7B, after the captured image is divided into correction areas, a minimum luminance value in all the pixels in each correction area is calculated (S203), and the calculated minimum luminance value is subtracted from the luminance value of each of all the pixels in the correction area (S204).

FIGS. 8C through 8E are diagrams for describing a correction processing to be performed with respect to the correction areas C1 through C3 shown in FIG. 8B. Referring to FIGS. 8C through 8E, the left diagrams are diagrams showing the luminance values in the correction area by the density of shading. As the hatching density is smaller, the luminance value is higher. The circles in FIGS. 8C through 8E show irradiation areas of dots. The middle diagrams in FIGS. 8C through 8E are diagrams, wherein the luminance value at each pixel position in the correction area is indicated by a numerical value. As the luminance value is higher, the numerical value is larger. The right diagrams in FIGS. 8C through 8E are diagrams, wherein the luminance values after the correction are indicated by numerical values.

Referring to the left diagram in FIG. 8C, since background light of a slightly strong intensity is uniformly entered to the correction area C1 shown in FIG. 8B, the luminances of the overall pixels are slightly high, and the luminance of the pixel where a dot is entered and the luminances of the pixels adjacent to the above pixel are further high.

Referring to the middle diagram in FIG. 8C, regarding the correction area C1, a dot is not entered to the pixels (luminance value=80) where the luminance value is smallest, and the pixels are not adjacent to the dot. By subtracting the luminance value 80, which is a minimum value among all the luminance values of the pixels in the correction area C1, from the luminance value of each of the pixels in the correction area C1, as shown in the right diagram in FIG. 8C, the luminance values of the pixels, other than the pixel where the dot is entered and the pixels adjacent to the above pixel, become zero. In this way, it is possible to remove an influence of background light with respect to the pixel values of the pixels in the correction area C1.

Referring to the left diagram in FIG. 8D, background light of a slightly strong intensity and background light of a weak intensity are entered to the correction area C2 shown in FIG. 8B. Further, the luminance of the pixel where a dot is entered is highest; and the luminances of the pixels adjacent to the above pixel, and the luminances of the pixels where background light of a slightly strong intensity is entered are substantially the same.

Referring to the middle diagram in FIG. 8D, regarding the correction area C2, a dot is not entered to the pixel (luminance value=40) where the luminance value is smallest, and the pixel is not adjacent to the dot. By subtracting the luminance value 40, which is a minimum value among all the luminance values of the pixels in the correction area C2, from a luminance value of each of the pixels in the correction area C2, as shown in the right diagram in FIG. 8D, the luminance values of the pixels where background light of a weak intensity is entered become zero. In this way, it is possible to remove an influence of background light with respect to the pixel values of the pixels where background light of a weak intensity is entered. Further, regarding the pixels other than the pixels where background light of a weak intensity is entered, the luminance values of the pixels other than the pixel where the dot is entered are lowered. Thus, an influence of background light is suppressed. Further, an influence of background light is also removed in the pixel where the dot is entered.

Referring to the left diagram in FIG. 8E, background light of a weak intensity is uniformly entered to the correction area C3 shown in FIG. 8B. Accordingly, the luminance values of the overall pixels are slightly high, and the luminance value of the pixel where a dot is entered and the luminance values of the pixels adjacent to the above pixel are further high.

Referring to the middle diagram in FIG. 8E, regarding the correction area C3, a dot is not entered to the pixel (luminance value=40) where the luminance value is smallest, and the pixel is not adjacent to the dot. By subtracting the luminance value 40, which is a minimum value among all the luminance values of the pixels in the correction area C3, from a luminance value of each of the pixels in the correction area C3, as shown in the right diagram in FIG. 8E, the luminance values of the pixels, other than the pixel where the dot is entered and the pixels adjacent to the above pixel, become zero. In this way, it is possible to remove an influence of background light with respect to the pixel values of the pixels other than the pixel where the dot is entered and the pixels adjacent to the above pixel.

As described above referring to FIGS. 8C through 8E, it is possible to remove an influence of background light with respect to a luminance value of each of the pixels, by subtracting a minimum luminance value among all the luminance values of the pixels in a correction area, from the luminance value of each of the pixels. Accordingly, by performing the aforementioned matching operation with use of the pixel values after the correction processing, it is possible to exclude the luminance values of background light from the sum Rsad of pixel value differences, thereby reducing the value Rsad by the exclusion.

For instance, referring to the middle diagram in FIG. 8C, if background light is not entered, the luminance value of a pixel whose luminance value is 80 becomes zero. Accordingly, inherently, the luminance value difference between the above pixel and a corresponding pixel in a segment area should be zero. However, in the middle diagram in FIG. 8C, the luminance value difference becomes 80 due to incidence of background light. If such an erroneous difference is summed up with respect to all the pixels, the sum Rsad of pixel value differences is exceedingly increased, as compared with the case where background light is not entered. As a result, a matching operation with respect to the segment area fails.

In contrast, in the right diagram in FIG. 8C, all the luminance values of six pixels whose luminance values should inherently be zero, are corrected to zero. Further, the luminance values of the pixels whose luminance value is 40 are suppressed, as compared with the example shown in the middle diagram of FIG. 8C. Accordingly, the sum Rsad of pixel value differences is lowered, as compared with the example shown in the middle diagram in FIG. 8C, and is approximated to an inherent value. As a result, a matching operation with respect to a segment area can be properly performed.

As shown in the example shown in FIG. 8D, in the case where the intensity of background light varies within a correction area, it is impossible to completely remove an influence of background light from a luminance value of a pixel where background light of a strong intensity is entered. However, even in such a case, a luminance value due to incidence of background light of a weak intensity is subtracted from the luminance value of the pixel where background light of a strong intensity is entered. Accordingly, it is possible to remove an influence of background light with respect to the luminance value of the pixel where background light of a strong intensity is entered to some extent. Thus, it is possible to enhance the matching precision with respect to a segment area.

There is a case that background light is not entered to the correction area C, as exemplified by the comparison area Td shown in FIG. 6B. In such a case, since a minimum luminance value is zero, the luminance values of all the pixels do not change even by the correction. Accordingly, even if the aforementioned correction processing is performed with respect to the comparison area Td, there is no influence to the matching operation with respect to a segment area.

Further, as exemplified by the comparison area Ta shown in FIG. 6B, in the case where background light of such a strong intensity that the CMOS image sensor 124 is saturated is uniformly entered to the correction area C, the luminance values of all the pixels become a maximum level (255), and the luminance values of all the pixels become zero by the correction. Accordingly, in the case where background light of such a strong intensity is entered to the CMOS image sensor 124, it is impossible to perform a matching operation, even if the correction processing is performed.

As described above, it is possible to effectively remove background light by dividing a captured image into correction areas C each having a predetermined pixel number in horizontal direction and a predetermined pixel number in vertical direction, and by subtracting a minimum luminance value in the correction area C with respect to all the pixels in the correction area C. In this arrangement, even if a captured image includes a region where background light is entered and a region where background light is not entered, it is possible to perform a matching operation with respect to a segment area that is created in an environment free of background light, with use of a certain threshold value.

In this embodiment, the size of the correction area C to be obtained by dividing a captured image is set to 3 pixels by 3 pixels. Alternatively, it is possible to set the size of the correction area C to other size.

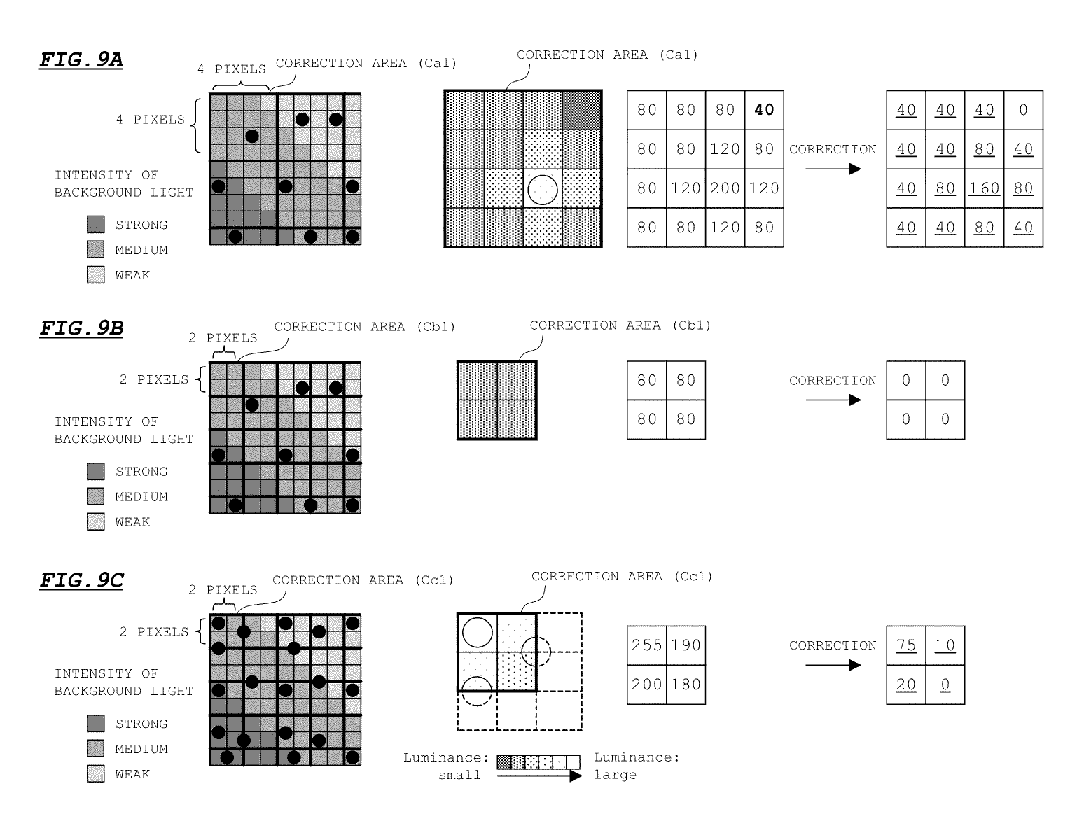

FIGS. 9A through 9C are diagrams showing another correction area dividing example.

FIG. 9A is a diagram showing a correction processing to be performed in the case where a captured image is divided into correction areas C each having a size of 4 pixels by 4 pixels. In this example, only one pixel where background light of a weak intensity is entered is included in the correction area Cal, and the luminance value of the above pixel is a minimum value 40 in the correction area Cal. Accordingly, it is impossible to completely remove background light in the pixels other than the one pixel, and a pixel value difference with respect to a corresponding pixel in a segment area is large.

As described above, if the correction area C is set to a large size, background light of different intensities is likely to be included in one correction area C, and the number of pixels from which an influence of background light cannot be completely removed is likely to increase.

FIG. 9B is a diagram of a correction processing to be performed in the case where a captured image is divided into correction areas C each having a size of 2 pixels by 2 pixels.

In the above arrangement, since the size of the correction area Cb is small, it is less likely that the intensity of background light may vary in the correction area Cb. Accordingly, the above arrangement makes it easy to allow background light to be uniformly entered to the correction area, and increases the probability of completely removing background light with respect to all the pixels in the correction area. In the example shown in FIG. 9B, the luminance values of all the pixels after the correction are set to zero.

However, if the size of a correction area is reduced, plural dots may be included in one correction area, depending on the density of dots. For instance, as shown in FIG. 9C, if the dot density increases, all the pixels may be influenced by dots in the correction area Cc having such a small size as 2 pixels by 2 pixels. In such a case, the luminance values of all the pixels in the correction area Cc are subtracted by a very high luminance value of a pixel that is influenced by a dot. This makes it impossible to properly remove only the background light.

As described above, it is advantageous to set the size of the correction area C to a smallest size as possible for removing background light. However, the correction area C should include at least one pixel that is not influenced by dots of DP light. Specifically, the size of the correction area C is decided in accordance with the density of dots of DP light to be entered to the correction area C. In the case where the total pixel number of a captured image is about three hundred thousands, and the number of dots to be created by the DOE 114 is about thirty thousands, as described in the embodiment, it is desirable to set the size of the correction area C to about 3 pixels by 3 pixels.

Referring back to FIG. 7B, after the captured image correction processing is completed with respect to all the correction areas, the corrected image is stored in the memory (S205). By performing the above operation, the captured image correction processing is completed.

Even in the case where background light is superimposed on a captured image, it is possible to create a corrected image free of background light by the processing shown in FIG. 7B. Then, it is possible to precisely detect a distance to an object to be detected by performing a matching operation and a distance measurement operation with use of the corrected image.

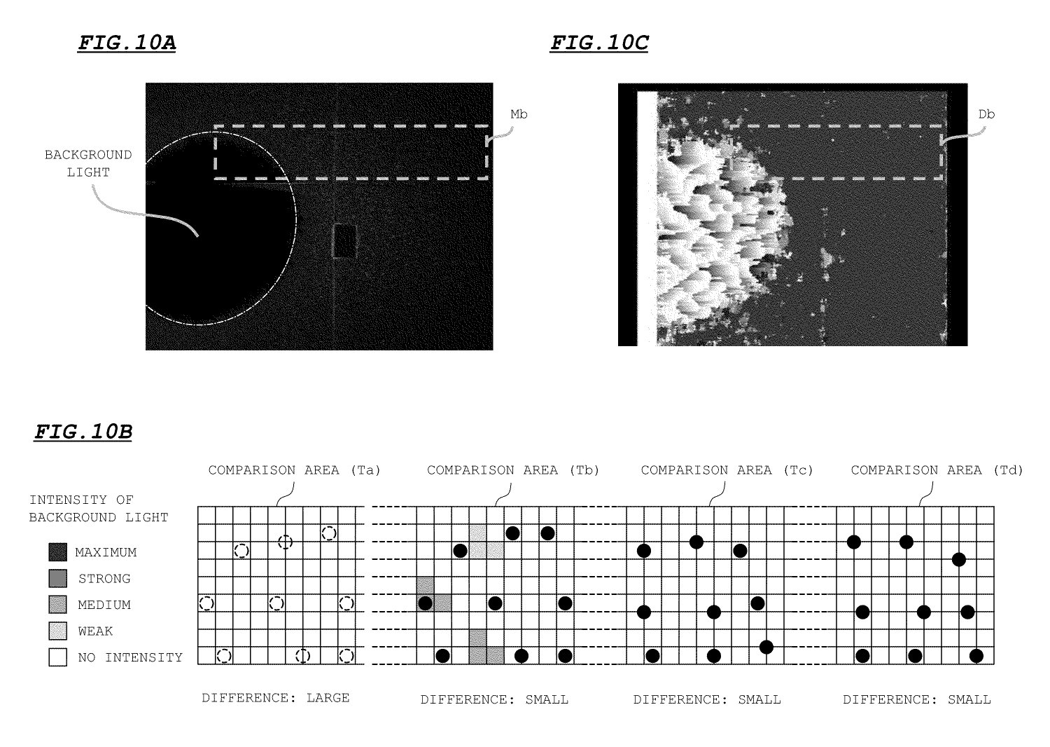

FIGS. 10A through 10C are diagrams showing a measurement example, in the case where a distance detection operation is performed with use of a corrected image obtained by correcting a captured image by the captured image corrector 21b.

FIG. 10A shows a corrected image obtained by correcting the captured image shown in FIG. 6A by the processing described referring to FIGS. 7A through 8E. Referring to FIG. 10A, the luminance of a pixel is higher in a portion whose color is closer to white, and the luminance of a pixel is lower in a portion whose color is closer to black.

As compared with the captured image shown in FIG. 6A, in the corrected image shown in FIG. 10A, a white region (luminance is maximum) due to incidence of background light of a strong intensity turns black (luminance is zero) by the correction. To simplify the description, the region where background light of a strong intensity is entered is indicated by the one-dotted chain line in FIG. 6A. Further, in the captured image shown in FIG. 6A, as the region is away from background light of a strong intensity, the intensity of background light decreases, and the color gradually turns pale black. In the corrected image shown in FIG. 10A, background light is removed, and the entirety of the corrected image uniformly turns black.

FIG. 10B is a diagram schematically showing examples of comparison areas in the region Mb enclosed by the white dash line in the corrected image shown in FIG. 10A. Referring to FIG. 10B, one square corresponds to one pixel in a corrected image, and a black circle indicates a dot of DP light. As the color density of the square increases, background light of a stronger intensity is entered. The region Mb in the corrected image corresponds to the region Ma in the captured image shown in FIG. 6A.

Regarding the comparison area Ta, as compared with the examples shown in FIG. 6B, although background light of a strong intensity is removed, the CMOS image sensor 124 is saturated. Accordingly, it is impossible to recognize the positions of dots of DP light, and the luminance values of all the pixels become zero. Accordingly, it is impossible to accurately detect a shift position of the comparison area Ta by the aforementioned detection method.

Regarding the comparison area Tb, as compared with the examples shown in FIG. 6B, almost all the background light can be removed, and the intensity of the remainder of background light is weak. Accordingly, the sum Rsad of pixel value differences between a segment area of the reference template and the comparison area Tb is reduced to some extent. In this way, as compared with the examples shown in FIG. 6B, it is easy to properly perform a matching operation between the corresponding segment area and the comparison area Tb, and to accurately perform a distance measurement operation by the aforementioned detection method.

Regarding the comparison area Tc, as compared with the examples shown in FIG. 6B, background light of a weak intensity that has been uniformly entered to the comparison area Tc is removed. Accordingly, the sum Rsad of pixel value differences between a segment area of the reference template and the comparison area Tc is small, and it is possible to properly perform a matching operation between the corresponding segment area and the comparison area Tb, and to accurately perform a distance measurement operation by the aforementioned detection method.

Further, regarding the comparison area Td, there is no influence of background light, and the luminance values do not change even by the correction. Accordingly, similarly to the example shown in FIG. 6B, the Rsad of pixel value differences between a segment area of the reference template and the comparison area Td is small, and it is possible to properly perform a matching operation between the corresponding segment area and the comparison area Tb, and to accurately perform a distance measurement operation by the aforementioned detection method.

FIG. 10C shows a distance measurement result, in the case where a matching operation is performed with respect to the corrected image shown in FIG. 10A, with use of the aforementioned detection method. FIG. 10C corresponds to FIG. 6C.

Referring to FIG. 10C, it is clear that a region where a distance is erroneously detected is limited to a region where background light of a strong intensity is irradiated, and that a distance is properly measured in a region other than the above region. A distance is also obtained with respect to the black test paper strip disposed at the middle in the diagram of FIG. 10C.

Referring to FIG. 10C, the region Db enclosed by the white dash line shows a matching result with respect to the region Mb shown in FIG. 10A. It is clear that a matching operation is substantially successful in a region other than the solid black region (circle enclosed by the white one-dotted chain line) shown in FIG. 10A.

In this way, in the measurement result shown in FIG. 10C, the region other than the region where the CMOS image sensor 124 is saturated turns substantially uniformly black. Thus, it is clear that the matching rate is remarkably improved, as compared with the example shown in FIG. 6C.

As described above, according to the embodiment, background light is removed from a captured image by the captured image corrector 21b. Accordingly, even in the case where background light is entered to the CMOS image sensor 124, it is possible to precisely detect a distance.

Further, according to the embodiment, the size of the correction area is set to 3 pixels by 3 pixels so that one or more pixels that is not influenced by dots of DP light are included in the correction area. Accordingly, it is possible to precisely correct a captured image.

Further, according to the embodiment, the size of the correction area is set to a sufficiently small size of 3 pixels by 3 pixels. Accordingly, it is less likely that background light of different intensities may be entered to the correction area, and it is possible to precisely correct a captured image.

Further, according to the embodiment, even if a target area includes a region where background light is entered and a region where background light is not entered, it is possible to remove a component of background light from the luminance values of pixels by correcting a captured image in the manner as described referring to FIGS. 7A through 8E, and to perform a matching operation for distance detection with use of a certain threshold value with respect to the value Rsad, regardless of whether background light is entered or not.

Further, according to the embodiment, it is possible to remove background light by correcting a captured image. Accordingly, it is possible to precisely detect a distance, with use of an inexpensive filter for transmitting light of a relatively wide transmissive wavelength band.

The embodiment of the invention has been described as above. The invention is not limited to the foregoing embodiment, and the embodiment of the invention may be changed or modified in various ways other than the above.

For instance, in the embodiment, to simplify the description, the diameter of a dot of DP light is set substantially equal to about the size of one pixel of a captured image. Alternatively, the diameter of a dot of DP light may be set larger or smaller than the size of one pixel of a captured image. In the case where the diameter of a dot of DP light is set larger than the size of one pixel, it is necessary to set the size of a correction area in such a manner that one or more pixels that is not influenced by dots of DP light is included in the correction area. Specifically, the size of a correction area is decided, depending on the ratio between the dot diameter of DP light and the size of one pixel of a captured image, in addition to the total pixel number of the CMOS image sensor 124 and the number of dots to be created by the DOE 114. The size of the correction area is set in such a manner that one or more pixels that is not influenced by dots of DP light is included in the correction area, based on these parameters. In this arrangement, it is possible to precisely remove background light from a captured image in the same manner as in the embodiment.

Further, in the embodiment, there is used the DOE 114 capable of substantially uniformly distributing dots with respect to a target area. Alternatively, for instance, it is possible to use a DOE capable of generating a dot pattern having such a non-uniform distribution that the dot density increases only in the peripheral portion of the dot pattern. In the modification, the size of the correction area may be set in accordance with an area where the dot density is highest, or the correction areas may have different sizes between an area where the dot density is high and an area where the dot density is low. For instance, the correction area of a large size is set for an area where the dot density is high, and the correction area of a small size is set for an area where the dot density is low. In this arrangement, it is possible to precisely remove background light from a captured image in the same manner as in the embodiment.

Further, in the embodiment, the size of the correction area is set to 3 pixels by 3 pixels. Alternatively, as far as there exist one or more pixels that is not influenced by dots of DP light, the size of the correction area may be set to other size. Further, it is desirable to set the size of the correction area to a smallest size as possible. In view of the above, the shape of the correction area is desirably a square shape, as described in the embodiment. However, a shape other than the above such as a rectangular shape may be applied.

Further, in the embodiment, a corrected image is generated by subtracting a minimum luminance value (pixel value) among all the luminance values (pixel values) of the pixels in the correction area, with respect to all the luminance values (pixel values) in the correction area. Alternatively, it is possible to correct the luminance value (pixel value) in the correction area, based on a minimum luminance value (pixel value) by e.g. subtracting a value obtained by multiplying a minimum luminance value (pixel value) with a predetermined coefficient, with respect to the luminance values (pixel values) in the correction area.

Further, in the embodiment, the resolution of the CMOS image sensor 124 corresponds to the resolution of VGA (640×480). Alternatively, the resolution of the CMOS image sensor may correspond to the resolution of other format such as XGA (1,024×768) or SXGA (1,280×1,024).

Further, in the embodiment, there is used the DOE 114 for generating DP light of about thirty thousand dots. Alternatively, the number of dots to be generated by the DOE may be other number.

Further, in the embodiment, segment areas are set in such a manner that the segment areas adjacent to each other do not overlap each other. Alternatively, segment areas may be set in such a manner that segment areas adjacent to each other in left and right directions may overlap each other, or that segment areas adjacent to each other in up and down directions may overlap each other.

Further, in the embodiment, the CMOS image sensor 124 is used as a light receiving element. Alternatively, a CCD image sensor may be used in place of the CMOS image sensor 124. Further alternatively, the arrangement of the light receiving optical system 12 may be modified, as necessary. Further alternatively, the information acquiring device 1 and the information processing device 2 may be integrally configured into one unit, or the information acquiring device 1 and the information processing device 2 may be integrally configured with a television, a game machine, or a personal computer.

The embodiment of the invention may be changed or modified in various ways as necessary, as far as such changes and modifications do not depart from the scope of the claims of the invention hereinafter defined.

What is claimed is:

1. An information acquiring device for acquiring information on a target area using light, comprising:
a projection optical system which projects laser light onto the target area with a predetermined dot pattern;
a light receiving optical system which is aligned with the projection optical system away from the projection optical system by a predetermined distance, and has an image pickup element for capturing an image of the target area;
a correcting section which divides a captured image obtained by capturing the image of the target area by the image pickup element at a time of actual measurement into a plurality of correction areas, and correcting a pixel value of a pixel in the correction area with use of a minimum pixel value among all pixel values of pixels in the correction area for generating a corrected image; and
an information acquiring section which acquires three-dimensional information of an object in the target area, based on the corrected image generated by the correcting section.

2. The information acquiring device according to claim 1, wherein
the information acquiring section sets a plurality of segment areas in the captured image including a reference dot pattern to be captured by the image pickup element when the dot pattern is irradiated onto a reference plane, searches a corresponding area corresponding to the segment area from the corrected image, and acquires three-dimensional information of the object in the target area, based on a position of the searched corresponding area.

3. The information acquiring device according to claim 1, wherein
the correcting section includes a processing of subtracting the minimum pixel value among all the pixel values of the pixels in the correction area, from the pixel value of each of all the pixels in the correction area.

4. The information acquiring device according to claim 1, wherein
the correction area is set to such a size as to include one or more pixels where a dot of the dot pattern is not entered.

5. The information acquiring device according to claim 1, wherein
the projection optical system includes:
a laser light source;
a collimator lens which converts laser light emitted from the laser light source into parallel light; and
a diffractive optical element which converts the laser light that has been converted into the parallel light by the collimator lens into light having a dot pattern by diffraction.

6. An object detecting device, comprising:
an information acquiring device which acquires information on a target area using light,
the information acquiring device including:
a projection optical system which projects laser light onto the target area with a predetermined dot pattern;
a light receiving optical system which is aligned with the projection optical system away from the projection optical system by a predetermined distance, and has an image pickup element for capturing an image of the target area;
a correcting section which divides a captured image obtained by capturing the image of the target area by the image pickup element at a time of actual measurement into a plurality of correction areas, and correcting a pixel value of a pixel in the correction area with use of a minimum pixel value among all pixel values of pixels in the correction area for generating a corrected image; and
an information acquiring section which acquires three-dimensional information of an object in the target area, based on the corrected image generated by the correcting section.

7. The object detecting device according to claim 6, wherein
the information acquiring section sets a plurality of segment areas in the captured image including a reference dot pattern to be captured by the image pickup element when the dot pattern is irradiated onto a reference plane, searches a corresponding area corresponding to the segment area from the corrected image, and acquires three-dimensional information of the object in the target area, based on a position of the searched corresponding area.

8. The object detecting device according to claim 6, wherein
the correcting section includes a processing of subtracting the minimum pixel value among all the pixel values of the pixels in the correction area, from the pixel value of each of all the pixels in the correction area.

9. The object detecting device according to claim 6, wherein
the correction area is set to such a size as to include one or more pixels where a dot of the dot pattern is not entered.

10. The object detecting device according to claim 6, wherein
the projection optical system includes:
a laser light source;
a collimator lens which converts laser light emitted from the laser light source into parallel light, and
a diffractive optical element which converts the laser light that has been converted into the parallel light by the collimator lens into light having a dot pattern by diffraction.
